(19) United States
(12) Patent Application Publication
(10) Pub. No.: US 2025/0103002 A1
(43) Pub. Date: Mar. 27, 2025

(54) IMAGE FORMING APPARATUS

(71) Applicant: FUJIFILM Business Innovation Corp., Tokyo (JP)

(72) Inventors: Go MIURA, Kanagawa (JP); Yutaka KIUCHI, Kanagawa (JP); Arichika TANAKA, Kanagawa (JP)

(73) Assignee: FUJIFILM Business Innovation Corp., Tokyo (JP)

(21) Appl. No.: 18/585,302

(22) Filed: Feb. 23, 2024

(30) Foreign Application Priority Data
Sep. 25, 2023 (JP) 2023-161486

(51) Int. Cl. G03G 21/18

(52) U.S. Cl. CPC G03G 21/186; G03G 21/1846

(57) ABSTRACT

An image forming apparatus includes an image holding body that is cylindrical, a rotation shaft that rotates the image holding body, a bearing that is provided at both ends of the rotation shaft and includes an outer ring and an inner ring rotatable relative to the outer ring, the inner ring and the rotation shaft inserted in the inner ring rotating integrally, a holding member that is attached to a main body side and holds the outer ring of the bearing, and a pressing section that presses the outer ring of the bearing against the holding member by pressing the outer ring in one direction.

### CROSS-REFERENCE TO RELATED APPLICATIONS

This application is based on and claims priority under 35 USC 119 from Japanese Patent Application No. 2023-161486 filed Sep. 25, 2023.

### BACKGROUND

### (i) Technical Field

The present disclosure relates to an image forming apparatus.

### (ii) Related Art

Japanese Unexamined Patent Application Publication No. 2002-287570 discloses a process cartridge that includes a developing cartridge and a photosensitive drum, in which bearing members are provided on an outer peripheral surface at both axial end portions at non-image forming regions of the photosensitive drum and, through the bearing members, the photosensitive drum is rotatably supported at three positions on its outer peripheral surface by L-shaped members and stopper members. As a result, the photosensitive drum is supported at its outer peripheral surface with extremely high precision, so that the eccentric rotation of the photosensitive drum is easily and reliably prevented, and proper images can be formed.

Japanese Unexamined Patent Application Publication No. 2005-275266 discloses an image forming apparatus that includes a photosensitive drum unit in which a photosensitive drum is rotatably disposed, the photosensitive drum unit being detachably disposed in an apparatus main body, and a positioning portion that positions the photosensitive drum unit in the apparatus main body. The image forming apparatus includes a drum shaft disposed in a longitudinal direction along a central axis of the photosensitive drum and having both end portions supported by a frame of the photosensitive drum unit, and a bearing disposed in a main frame of the apparatus main body so as to be fitted to one end of the drum shaft protruding from a side surface of the photosensitive drum unit. In a state where the photosensitive drum unit is positioned by the positioning portion, the drum shaft is inserted in the bearing.

### SUMMARY

In a configuration in which an image holding body for holding an image can be replaced as a single body, the image holding body and a bearing for supporting a rotation shaft of the image holding body are integrally formed, and the image holding body is attached to a main body side through a member for holding the bearing. However, in a case where a gap enabling replacement is present between the bearing and the member for holding the bearing, the gap causes the rotation shaft to fluctuate during rotation of the image holding body, whereby the image holding member is vibrated, and an image defect occurs.

Aspects of non-limiting embodiments of the present disclosure relate to suppressing vibration of the image holding body even in a case where a gap is present between the bearing that rotatably supports the rotation shaft of the image holding body and the member for holding the bearing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an image holding body that is cylindrical, a rotation shaft that rotates the image holding body, a bearing that is provided at both ends of the rotation shaft and includes an outer ring and an inner ring rotatable relative to the outer ring, the inner ring and the rotation shaft inserted in the inner ring rotating integrally, a holding member that is attached to a main body side and holds the outer ring of the bearing, and a pressing section that presses the outer ring of the bearing against the holding member by pressing the outer ring in one direction.

### BRIEF DESCRIPTION OF THE DRAWINGS

An exemplary embodiment of the present disclosure will be described in detail based on the following figures, wherein:

FIG. 1 is a diagram for explaining an image forming apparatus to which the exemplary embodiment is applied;

FIG. 2 is a diagram for explaining a state in which a photoreceptor drum is attached in an image forming unit;

FIG. 3 is a perspective view illustrating one end side of a photoreceptor drum to which the exemplary embodiment is applied;

FIG. 4 is a view for explaining a holder, and is a perspective view illustrating a state in which the holder is attached to the photoreceptor drum of FIG. 3; and

FIG. 5 is a view illustrating a cross section taken along line V-V in FIG. 2, and is a view illustrating a state in which the holder with the photoreceptor drum is attached to a frame.

### DETAILED DESCRIPTION

In the following, an exemplary embodiment of the present disclosure will be described in detail with reference to the accompanying drawings.

### Description of Image Forming Apparatus 1

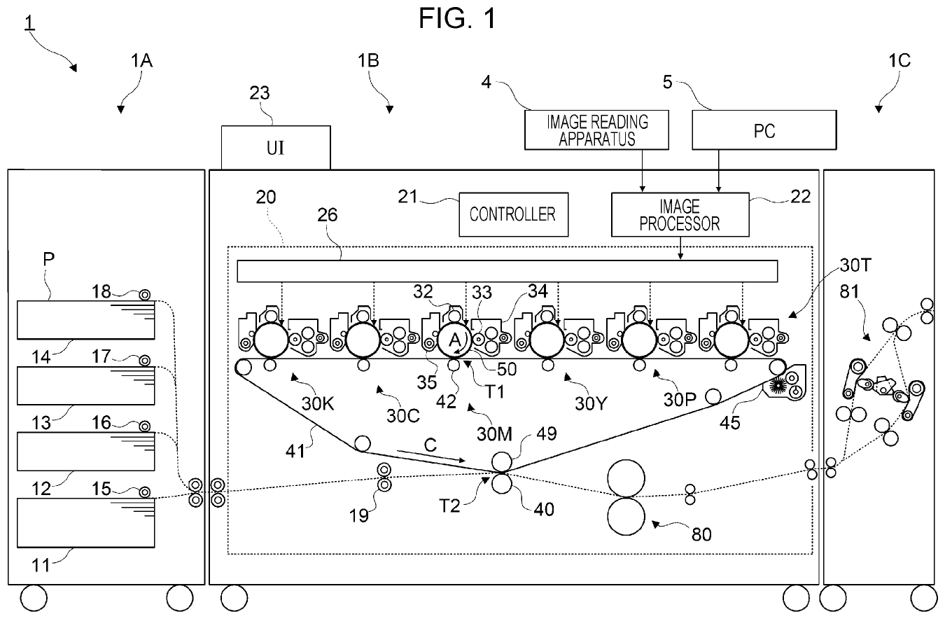

FIG. 1 is a diagram for explaining an image forming apparatus 1 to which the exemplary embodiment is applied.

The image forming apparatus 1 according to the exemplary embodiment includes a paper feed unit 1A, a printing unit 1B, and a paper discharge unit 1C.

The paper feed unit 1A includes a first paper storage 11 to a fourth paper storage 14 that store paper P as an example of recording media.

The paper feed unit 1A also includes delivery rollers 15 to 18 that are provided corresponding to the first paper storage 11 to the fourth paper storage 14, respectively, and deliver the paper P stored in each paper storage to a transport path connected to the printing unit 1B.

The printing unit 1B includes an image forming part 20 that forms an image on the paper P. The printing unit 1B includes a controller 21 that controls each part of the image forming apparatus 1.

The printing unit 1B also includes an image processor 22. The image processor 22 performs image processing on image data transmitted from an image reading apparatus 4 or a personal computer (PC) 5.

The printing unit 1B includes a user interface (UI) 23 that is formed by a touch panel and the like, and that notifies a user of information and receives an input of information from a user.

The image forming part 20 includes six image forming units 30T, 30P, 30Y, 30M, 30C, and 30K (hereinafter, may be simply referred to as the “image forming unit 30”) arranged in parallel at regular intervals.

Each image forming unit 30 includes a photoreceptor drum 50 on which an electrostatic latent image is formed while rotating in the direction of arrow A, a charging roller 32 that charges the surface of the photoreceptor drum 50, a developing device 34 including a developing roller 33 that develops the electrostatic latent image formed on the photoreceptor drum 50, and a drum cleaner 35 that removes toner and the like from the surface of the photoreceptor drum 50. The photoreceptor drum 50 is provided so that the center of the rotation shaft of the photoreceptor drum 50 and the center of the rotation axis of the developing roller 33, which is an example of a developer holding body, are at the same height.

The image forming part 20 includes an exposure device 26 that exposes the photoreceptor drum 50 of each image forming unit 30 to laser light.

Note that the exposure of the photoreceptor drum 50 by the exposure device 26 is not limited to the use of laser light. For example, a light source such as a light emitting diode (LED) may be provided for each image forming unit 30, and the photoreceptor drum 50 may be exposed to light emitted from the light source.

Each image forming unit 30 has the same configuration except for a toner stored in the developing device 34. The image forming units 30Y, 30M, 30C, 30K form yellow (Y), magenta (M), cyan (C), and black (K) toner images, respectively.

The image forming units 30T and 30P form toner images using toners corresponding to corporate colors, foaming toners for Brailles, fluorescent color toners, toners for improving glossiness, and the like. In other words, the image forming units 30T and 30P form toner images using extra color toners.

The image forming part 20 includes an intermediate transfer belt 41 to which the toner images in respective colors formed on the photoreceptor drums 50 of the image forming units 30 are transferred.

The image forming part 20 includes primary transfer rollers 42 that transfer the toner images in respective colors of the image forming units 30 to the intermediate transfer belt 41 at respective primary transfer sections T1.

The image forming part 20 includes a secondary transfer roller 40 that transfers at once the transferred toner images on the intermediate transfer belt 41 onto the paper P at a secondary transfer section T2.

The image forming part 20 further includes a belt cleaner 45 that removes toner and the like from the surface of the intermediate transfer belt 41, and a fixing device 80 that fixes the secondary-transferred images on the paper P.

The image forming part 20 performs an image forming operation on the basis of a control signal from the controller 21.

To be specific, in the image forming part 20, first, the image processor 22 performs image processing on image data input from the image reading apparatus 4 or the PC 5, and resulting image data obtained by the image processing is supplied to the exposure device 26.

Then, in the image forming unit 30M for magenta (M), for example, the surface of the photoreceptor drum 50 is charged by the charging roller 32, and then the exposure device 26 irradiates the photoreceptor drum 50 with laser light modulated by the image data obtained from the image processor 22.

As a result, an electrostatic latent image is formed on the photoreceptor drum 50.

The formed electrostatic latent image is developed by the developing device 34, and a magenta toner image is formed on the photoreceptor drum 50.

Similarly, yellow, cyan, and black toner images are formed in the image forming units 30Y, 30C, and 30K, respectively, and toner images in extra colors are formed in the image forming units 30T and 30P.

The toner images in respective colors formed by the image forming units 30 are sequentially electrostatically transferred by the respective primary transfer rollers 42 onto the intermediate transfer belt 41 rotating in the direction of arrow C in FIG. 1, so that a superimposed toner image is formed on the intermediate transfer belt 41.

With the movement of the intermediate transfer belt 41, the superimposed toner image formed on the intermediate transfer belt 41 is transported to the secondary transfer section T2 formed by the secondary transfer roller 40 and a backup roller 49.

Meanwhile, the paper P is taken out from the first paper storage 11 by, for example, the delivery roller 15, and then transported to the position of a registration roller 19 via the transport path.

Once the superimposed toner image is transported to the secondary transfer section T2, the paper P is supplied, at this timing, from the registration roller 19 to the secondary transfer section T2.

Then, in the secondary transfer section T2, the superimposed toner image is electrostatically transferred at once onto the paper P by the action of a transfer electric field formed between the secondary transfer roller 40 and the backup roller 49.

Thereafter, the paper P onto which the superimposed toner image is electrostatically transferred is transported to the fixing device 80.

The fixing device 80 performs processing of fixing the toner image on the paper P by pressurizing and heating the paper P on which the unfixed toner image is formed.

Then, the paper P subjected to the fixing processing is transported to a paper stacking part (not illustrated) through a curl correcting section 81 provided in the paper discharge unit 1C.

### Description of Image Forming Unit 30

Next, the image forming unit 30 to which the exemplary embodiment is applied will be described.

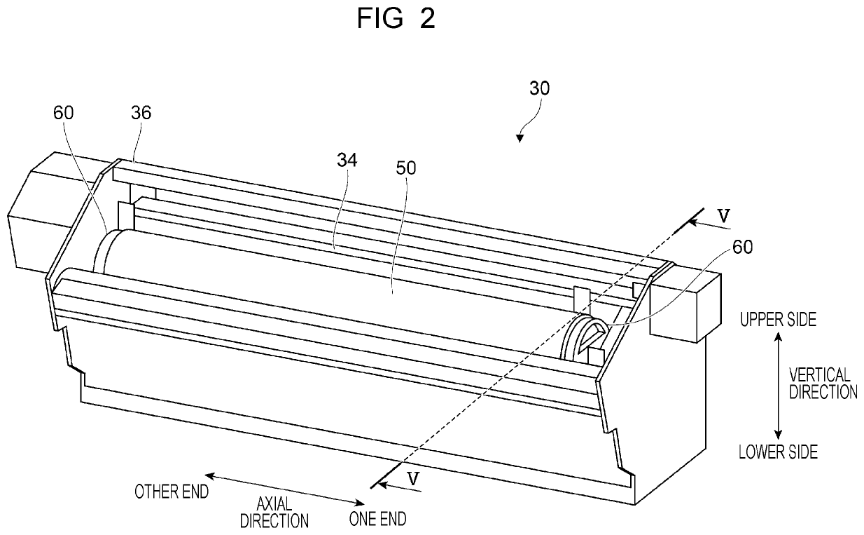

FIG. 2 is a diagram for explaining a state in which the photoreceptor drum 50 is attached in the image forming unit 30.

The image forming unit 30 includes a frame 36 to which various devices such as the photoreceptor drum 50 and the developing device 34 are attached, and holders 60 for attaching the photoreceptor drum 50 to the frame 36. The holders 60 are provided at respective ends (one end and the other end) in the axial direction of the photoreceptor drum 50. Note that the holder 60 provided at one end and the holder 60 provided at the other end have bilaterally symmetrical portions, for example, and do not have the identical shape.

### Description of Photoreceptor Drum 50

Next, the photoreceptor drum 50 will be described in more detail.

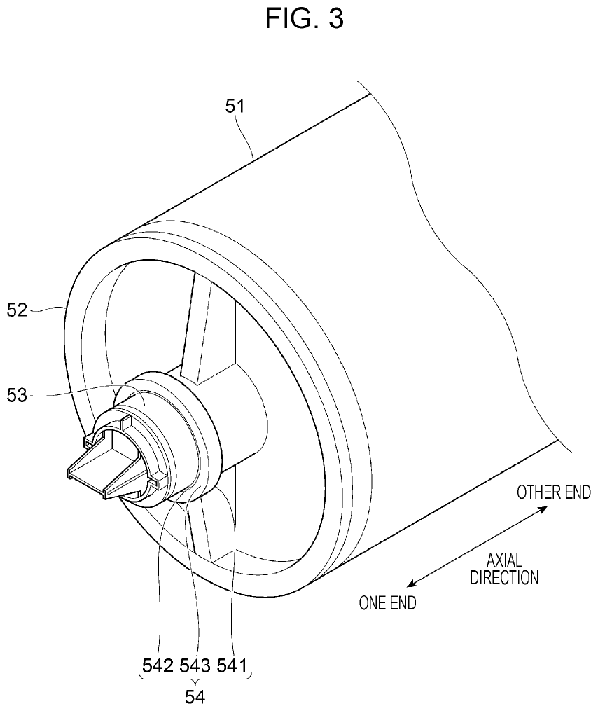

FIG. 3 is a perspective view illustrating one end side of the photoreceptor drum 50 to which the exemplary embodiment is applied. The photoreceptor drum 50 includes a cylindrical photoreceptor 51 functioning as an image holding body that holds an electrostatic latent image, and flanges 52 provided at both ends of the photoreceptor 51. The photoreceptor drum 50 also includes a rotation shaft 53 passing the center of the photoreceptor 51 and integrated with the flanges 52, and bearings 54 provided at both ends of the rotation shaft 53.

The flanges 52 are provided at openings at both ends of the photoreceptor 51, and the bearings 54 are press-fitted to the rotation shaft 53. The flange 52 rotates, and the photoreceptor 51 rotates along with the rotation of the flange 52.

The bearing 54 includes an outer ring 541, an inner ring 542, and a rolling element portion 543 that enables the inner ring 542 to rotate relative to the outer ring 541. The outer ring 541 and the inner ring 542 are provided on a concentric circle. The rolling element portion 543 is formed by a plurality of spherical or columnar rolling elements, for example. The rotation shaft 53 is press-fitted to the inner ring 542, and the outer ring 541 is fixed to the main body side, whereby the photoreceptor 51 is rotatably held with respect to the main body side.

### Description of Holder 60

Next, the holder 60 that holds the photoreceptor drum 50 will be described.

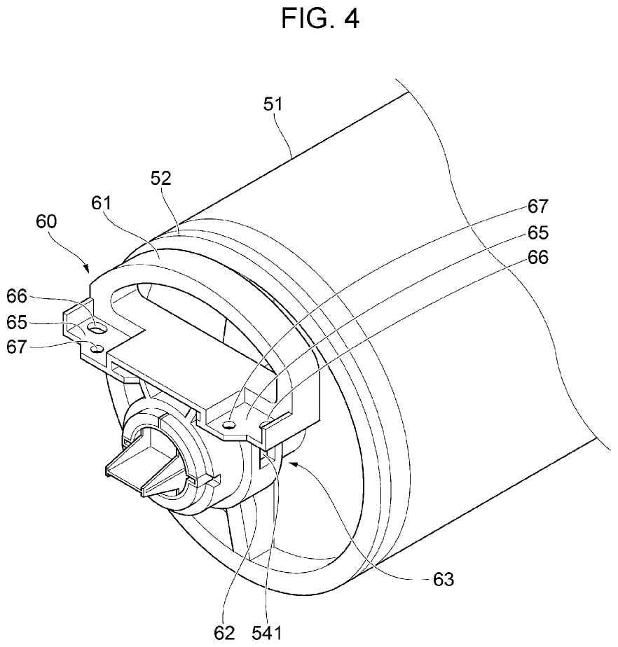

FIG. 4 is a view for explaining the holder 60, and is a perspective view illustrating a state in which the holder 60 is attached to the photoreceptor drum 50 of FIG. 3.

The holders 60 provided at one end and the other end of the photoreceptor drum 50 each includes a handle 61 for a user to grip the holder 60, a bearing surrounding portion 62 in contact with the outer ring 541 of the photoreceptor drum 50, and a pressing opening 63 that is an opening for pressing the outer ring 541 from a direction intersecting the axial direction. The holder 60 also includes installation surfaces 65 where the holder 60 is installed with respect to the frame 36 (see FIG. 2), positioning portions 66 that determine the position of the holder 60 with respect to the frame 36, and fixing portions 67 that fix the holder 60 to the frame 36. The bearing surrounding portion 62 surrounds and holds the bearing 54 (see FIG. 3) attached to the photoreceptor drum 50. The inner periphery of the bearing surrounding portion 62 has a cylindrical shape, and the inner peripheral dimension is obtained by adding the dimension of a clearance allowing the attachment and detachment of the photoreceptor drum 50 to the outer peripheral dimension of the outer ring 541 of the bearing 54. That is, a gap is formed between the bearing 54 that rotatably supports the rotation shaft 53 of the photoreceptor drum 50 and the bearing surrounding portion 62 as a member for holding the bearing 54.

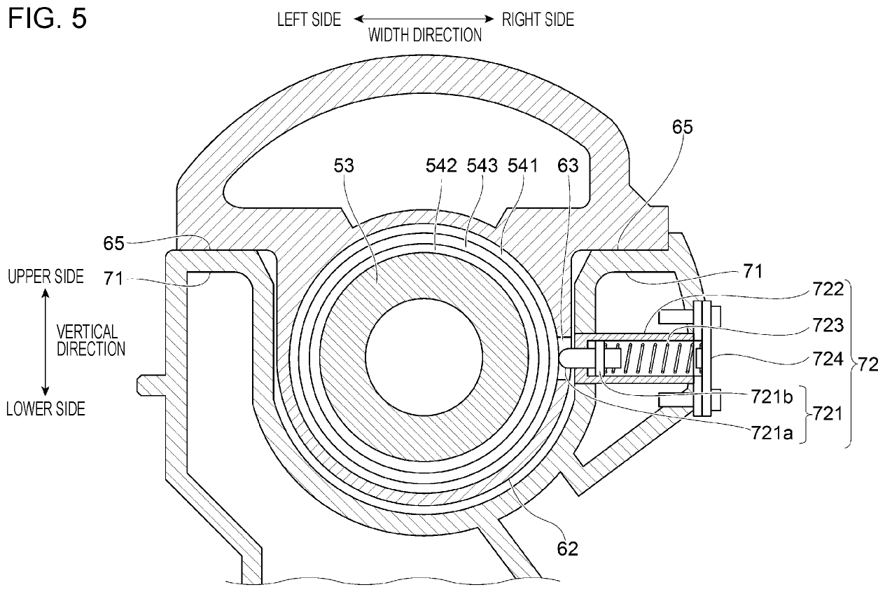

The pressing opening 63 is an opening formed in the holder 60 for pressing the outer ring 541 in one direction after the holder 60 is attached to the photoreceptor drum 50, and exposes a part of the outer ring 541 from the holder 60. The size of the opening of the pressing opening 63 is at least a size allowing a distal end portion 721a (see FIG. 5) of a pressing pin 721 (see FIG. 5) of a pressing section 72 described later to pass through.

The installation surfaces 65 are surfaces that come into contact with the frame 36 when the holder 60 is attached to the frame 36.

Each of the positioning portions 66 is a circular through hole arranged on the installation surface 65. A columnar projection provided on the frame 36 is inserted into each of the positioning portions 66 so as to position the holder 60 and the frame 36.

Each of the fixing portions 67 is a through hole disposed on the installation surface 65 and allowing a bolt to pass therethrough. The holder 60 is fixed to the frame 36 with bolts through these through holes.

### Description of Pressing Section 72

Next, the pressing section 72 that presses the outer ring 541 will be described with reference to FIG. 5.

FIG. 5 is a view illustrating a cross section taken along line V-V in FIG. 2, and is a view illustrating a state in which the holder 60 with the photoreceptor drum 50 is attached to the frame 36.

The frame 36 includes a support surface 71 that is in contact with the installation surface 65 of the holder 60 to support the holder 60, and the pressing section 72 that presses the outer ring 541.

The pressing section 72 includes the pressing pin 721 that presses the outer ring 541 through the pressing opening 63 of the holder 60, and a cylindrical sliding part 722 that moves the pressing pin 721 in one direction. The pressing section 72 also includes a compression spring 723 as an example of an elastic member applying force to the pressing pin 721 in one direction, and a presser plate 724 as a base of the pressing section 72.

The pressing pin 721, to which one end of the compression spring 723 is attached, presses the outer ring 541 by the extending force of the compression spring 723.

The pressing pin 721 includes the distal end portion 721a that comes into contact with the outer ring 541 and a sliding portion 721b that is in sliding contact with the inner periphery of the sliding part 722.

The distal end portion 721a is a hemispherical projection provided at an end portion of the pressing pin 721. When the pressing pin 721 comes into contact with the outer ring 541, the distal end portion 721a comes into contact with the outer ring 541. This reduces an impact applied to the outer ring 541 and suppresses damages to the outer ring 541, for example.

The sliding portion 721b is a column along the inner periphery of the sliding part 722, and suppresses the pressing pin 721 from being inclined in the sliding part 722. The sliding portion 721b also receives the compression spring 723 attached to the pressing pin 721 not to come off to the distal end portion 721a side.

The sliding part 722 holds the pressing pin 721 so that the pressing pin 721 moves along the inner periphery of the cylinder. The sliding part 722 is arranged so that the rotation shaft 53 of the photoreceptor drum 50 and the rotation axis of the developing roller 33 are positioned on the extended line of the center line of the cylinder of the sliding part 722. That is, the pressing pin 721 moves in a direction connecting the axis of the developing roller 33 (see FIG. 1) and the rotation shaft 53 of the photoreceptor drum 50 (see FIG. 1).

The presser plate 724 is attached to the frame 36, and the sliding part 722 and the compression spring 723 are attached to the presser plate 724.

The pressing section 72 attached to the frame 36 on one end side in FIG. 2 has been described with reference to FIG. 5. However, the pressing section 72 is also attached to the frame 36 on the other end side in FIG. 2. The pressing section 72 on the other end side is disposed so as to press the outer ring 541 in the same direction as the pressing direction of the pressing section 72 on the one end side. In other words, the pressing sections 72 provided at both ends of the rotation shaft 53 are arranged so as to press the outer rings 541 at both ends in the same direction.

### Replacement of Photoreceptor Drum 50

Next, the operation of replacing the photoreceptor drum 50 will be described with reference to FIG. 2 and FIG. 5.

To remove the photoreceptor drum 50 of the image forming unit 30 illustrated in FIG. 2 from the frame 36, the bolts attached to the fixing portions 67 (see FIG. 4) of the holders 60 are removed.

Then, the handles 61 of both the holders 60 are gripped, and the photoreceptor drum 50 is pulled out together with the holders 60 to the upper side in FIG. 2 to remove the photoreceptor drum 50 from the frame 36. Then, the holders 60 attached to both ends of the photoreceptor drum 50 are removed. Then, the holders 60 are attached to both ends of the new photoreceptor drum 50, and the photoreceptor drum 50 is attached to the frame 36 together with the holders 60.

If the holder 60 is moved to the lower side in the vertical direction with respect to the frame 36 when the photoreceptor drum 50 is attached to the frame 36, an arc-shaped portion on the lower side of the bearing surrounding portion 62 of the holder 60 comes into contact with the distal end portion 721a of the pressing pin 721. Then, as the holder 60 is further lowered, the pressing pin 721 is pressed by the bearing surrounding portion 62, so that the pressing pin 721 moves to the right side in the width direction. When the holder 60 moves further downward, the distal end portion 721a of the pressing pin 721 moves toward the center in the width direction through the pressing opening 63 of the holder 60. As a result, the pressing pin 721 presses the outer ring 541 from the right side toward the center in the width direction.

As illustrated in FIG. 5, the pressing pin 721 passing through the pressing opening 63 provided in the holder 60 presses the outer ring 541 from the right side toward the center in the width direction. Also on the other end side (see FIG. 2) of the photoreceptor drum 50, the pressing pin 721 presses the outer ring 541 in the same manner. As a result, the outer rings 541 at both ends of the photoreceptor drum 50 are pressed against the bearing surrounding portions 62 of the holders 60, thus suppressing the movement of the outer rings 541 in the bearing surrounding portions 62.

As described above in detail, in the image forming apparatus 1 to which the exemplary embodiment is applied, the outer ring 541 of the photoreceptor drum 50 is pressed so as to suppress the movement of the outer ring 541 due to the gap between the outer ring 541 and the holder 60, and thus the vibration of the photoreceptor drum 50 caused by the movement of the rotation shaft 53 is suppressed.

### APPENDIX

(((1)))

An image forming apparatus comprising:
an image holding body that is cylindrical;
a rotation shaft that rotates the image holding body;
a bearing that is provided at both ends of the rotation shaft and includes an outer ring and an inner ring rotatable relative to the outer ring, the inner ring and the rotation shaft inserted in the inner ring rotating integrally;

a holding member that is attached to a main body side and holds the outer ring of the bearing; and

a pressing section that presses the outer ring of the bearing against the holding member by pressing the outer ring in one direction.

(((2)))

The image forming apparatus according to (((1))), wherein the outer ring of the bearing is pressed in the one direction after the holding member is attached to the main body side.

(((3)))

The image forming apparatus according to (((1))) or (((2))), further comprising: a developer holding body that is provided along an axial direction of the image holding body attached to the main body side and develops the image holding body, wherein the one direction in which the pressing section presses the outer ring is a direction connecting an axis of the developer holding body and an axis of the image holding body.

(((4))) The image forming apparatus according to any one of (((1))) to (((3))), wherein the pressing section presses the outer ring using an elastic member.
(((5)))

The image forming apparatus according to any one of (((1))) to (((4))), wherein the holding member includes a surrounding portion that surrounds a periphery of the outer ring of the bearing and is detachable with respect to the outer ring.

(((6)

The image forming apparatus according to (((5))), wherein the surrounding portion has an opening that exposes a part of the outer ring, and the pressing section presses the outer ring through the opening.

(((7)))

The image forming apparatus according to any one of (((1))) to (((6))), wherein the pressing section is provided on the main body side.

(((8)))

The image forming apparatus according to (((7))), wherein the holding member is provided at both ends of the rotation shaft, and the pressing section presses the outer ring in a same direction on both ends of the rotation shaft.

What is claimed is:

1. An image forming apparatus comprising:
an image holding body that is cylindrical;
a rotation shaft that rotates the image holding body;
a bearing that is provided at both ends of the rotation shaft and includes an outer ring and an inner ring rotatable relative to the outer ring, the inner ring and the rotation shaft inserted in the inner ring rotating integrally;
a holding member that is attached to a main body side and holds the outer ring of the bearing; and
a pressing section that presses the outer ring of the bearing against the holding member by pressing the outer ring in one direction.

2. The image forming apparatus according to claim 1, wherein the outer ring of the bearing is pressed in the one direction after the holding member is attached to the main body side.

3. The image forming apparatus according to claim 2, further comprising:
a developer holding body that is provided along an axial direction of the image holding body attached to the main body side and develops the image holding body, wherein
the one direction in which the pressing section presses the outer ring is a direction connecting an axis of the developer holding body and an axis of the image holding body.

4. The image forming apparatus according to claim 3, wherein the pressing section presses the outer ring using an elastic member.

5. The image forming apparatus according to claim 1, wherein the holding member includes a surrounding portion that surrounds a periphery of the outer ring of the bearing and is detachable with respect to the outer ring.

6. The image forming apparatus according to claim 5, wherein
the surrounding portion has an opening that exposes a part of the outer ring, and
the pressing section presses the outer ring through the opening.

7. The image forming apparatus according to claim 1, wherein the pressing section is provided on the main body side.

8. The image forming apparatus according to claim 7, wherein
the holding member is provided at both ends of the rotation shaft, and
the pressing section presses the outer ring in a same direction on both ends of the rotation shaft.
